(19) United States
(12) Patent Application Publication
(10) Pub. No.: US 2011/0244285 A1
(43) Pub. Date: Oct. 6, 2011

(54) SECONDARY CELL AND METHOD OF MANUFACTURE THEREOF

(76) Inventor: Hideki SHINOHARA, Hitachiota-shi (JP)

(21) Appl. No.: 13/075,338

(22) Filed: Mar. 30, 2011

(30) Foreign Application Priority Data
Apr. 1, 2010 (JP) 2010-085107

(51) Int. Cl. H01M 4/00; H01M 10/04; H01M 4/64

(52) U.S. Cl. 429/94; 29/623.2

(57) ABSTRACT

In a secondary cell according to the present invention, one end portion of the electrically conductive lead is connected to the lid unit; and wherein other end portion of the electrically conductive lead is connected to the current collecting member; and the current collecting member and the lid unit are electrically connected together by a electrically conductive lead, of which one end portion that is connected to the lid unit is positioned opposite relative to a central plane of the container from the other end portion that is connected to the current collecting member, and that furthermore has one folded portion at a location partway therealong, or none.

### INCORPORATION BY REFERENCE

The disclosure of the following priority application is herein incorporated by reference: Japanese Patent Application No. 2010-085107 filed Apr. 1, 2010.

### BACKGROUND OF THE INVENTION

1. Field of the Invention

The present invention relates to a secondary cell, and to a method of manufacture thereof.

2. Description of Related Art

In a cylindrical secondary cell, of which a lithium secondary cell is representative, an electrode group is made by winding together, around the outside of a winding core with the interposition of separators, a positive electrode upon which is formed a layer of positive electrode mixture and a negative electrode upon which is formed a layer of negative electrode mixture. A positive electrode current collecting member is provided at the upper portion of this electrode group, and a plurality of positive leads of the positive electrode, normally termed “tabs”, are connected to this positive electrode current collecting member. A lid member is disposed above the positive electrode current collecting member, and the positive electrode current collecting member and this lid member are connected together by a flexible lead plate (an electrically conductive lead). The lid member keeps the electrode group and the positive electrode current collecting member inside the cell container, and, after electrolyte has been injected into the cell container, the lid member is sealed by swaging to the cell container with the interposition of an insulating member, so that the secondary cell is sealed up from the exterior.

There is a per se known method for connecting together the positive electrode current collecting member and the lid member with an electrically conductive lead, that will now be described. Two electrically conductive leads are used, each made by bundling together a plurality of thin aluminum plates, and one end portion of one of these electrically conductive leads is welded by ultrasonic welding to a lid member that has been swaged to a cleavage plate or the like. And one end portion of the other electrically conductive lead is welded by ultrasonic welding to the positive electrode current collecting member that is held in the cell container. Then the other end portions of the two electrically conductive leads described above are welded together by ultrasonic welding (for example, refer to Japanese Laid-Open Patent Publication 2004-152707). Since, in the method described in this Japanese Laid-Open Patent Publication 2004-152707, two electrically conductive leads are used, accordingly the total length of the finished electrically conductive lead becomes long, and this means that the internal resistance of the cell becomes somewhat greater. Moreover, the number of welding processes required to be performed upon the electrically conductive leads is increased.

And, as a construction for a secondary cell that uses only a single electrically conductive lead, a structure is per se known in which one end of an electrically conductive lead is joined to the positive electrode current collecting member, the lead is brought to the opposite side relative to the central plane that includes the central axis of the secondary cell and is then bent around and folded so that its other end portion returns to the same side as the first end portion, and that other end is then joined to the lid member in this position. In this case, the cell container and the lid member are sealed together after the electrical connection between the positive electrode current collecting member and the lid member has been established with the electrically conductive lead (for example, refer to Japanese Laid-Open Patent Publication Heisei 11-307076).

### SUMMARY OF THE INVENTION

With the construction for a secondary cell described in Japanese Laid-Open Patent Publication Heisei 11-307076, since only one electrically conductive lead is used, it is possible to shorten the length of the electrically conductive lead to be shorter than in the case of the construction described in Japanese Laid-Open Patent Publication 2004-152707, in which two electrically conductive leads are used. However, even with the secondary cell described in Japanese Laid-Open Patent Publication Heisei 11-307076, the length of the lead is still rather great, since the lead is bent around at the opposite side of the central plane including the central axis of the secondary cell and folded so that its other end portion is returned to the same side relative to the central plane of the secondary cell as its first end portion. Moreover, in Japanese Laid-Open Patent Publication Heisei 11-307076, there is no disclosure regarding any method of manufacturing a secondary cell that has a single short electrically conductive lead. And, even supposing that an ultrasonic welding method such as the one described in Japanese Laid-Open Patent Publication 2004-152707 is employed, the electrically conductive lead shown in FIG. 2 is too short.

According to the 1st aspect of the present invention, a secondary cell, comprises: a cell container receiving an electrode group, a current collecting member, a flexible electrically conductive lead and an electrolyte, and sealed with a lid unit via an insulation member; wherein the electrode group comprises a positive electrode and a negative electrode wound around a winding core; and wherein the current collecting member is arranged on the upper portion of the electrode group; and wherein one of the positive electrode and the negative electrode is connected to the current collecting member; and wherein the lid unit is arranged on the current collecting member; and wherein one end portion of the electrically conductive lead is connected to the lid unit; and wherein other end portion of the electrically conductive lead is connected to the current collecting member; and, the current collecting member and the lid unit are electrically connected together by the electrically conductive lead, of which the one end portion that is connected to the lid unit is positioned opposite relative to a central plane of the container from the other end portion that is connected to the current collecting member, and that furthermore has one folded portion at a location partway therealong, or none.

According to the 2nd aspect of the present invention, a secondary cell, comprises: a cell container receiving an electrode group, a current collecting member, a flexible electrically conductive lead and an electrolyte, and sealed with a lid unit via an insulation member; wherein the electrode group comprises a positive electrode and a negative electrode wound around a winding core; and wherein the current collecting member is arranged on the upper portion of the electrode group; and wherein one of the positive electrode and the negative electrode is connected to the current collecting member; and wherein the lid unit is arranged on the current collecting member; and wherein one end portion of the electrically conductive lead is connected to the lid unit; and wherein other end portion of the electrically conductive lead is connected to the current collecting member; and, the current collecting member and the lid unit are electrically connected together by the electrically conductive lead, of which the one end portion that is connected to the lid unit and a folded portion that is positioned between the one end portion and the other end portion are both positioned on a same side relative to a central plane of the container as the other end portion that is connected to the current collecting member.

According to the 3rd aspect of the present invention, in a secondary cell according to the 1st aspect, it is preferred that the electrically conductive lead is formed by laminating together a plurality of thin electrically conductive layers, and the surface of the electrically conductive lead is covered with an insulation layer, except for the other end portion that is connected to the current collecting member and the one end portion that is connected to the lid unit.

According to the 4th aspect of the present invention, in a secondary cell according to the 1st aspect, it is preferred that the electrically conductive lead has the folded portion in the vicinity of the one end portion that is connected to the lid unit.

According to the 5th aspect of the present invention, in a secondary cell according to the 1st aspect, it is preferred that the electrically conductive lead has the folded portion in the vicinity of the other end portion that is connected to the current collecting member.

According to the 6th aspect of the present invention, in a secondary cell according to the 1st aspect, it is preferred that the electrically conductive lead is formed in an approximately rectilinear shape from the other end portion that is connected to the current collecting member to the one end portion that is connected to the lid unit, with no portion thereof being substantially curved.

According to the 7th aspect of the present invention, in a secondary cell according to the 1st aspect, it is preferred that the lid unit comprises a connection plate to which the one end portion of the electrically conductive lead is connected, a diaphragm to which the connection plate is connected, and a lid member that is swaged to the diaphragm.

According to the 8th aspect of the present invention, a method for manufacturing a secondary cell that comprises: a cell container receiving an electrode group, a current collecting member, a flexible electrically conductive lead and an electrolyte, and sealed with a lid unit via an insulation member; wherein the electrode group comprises a positive electrode and a negative electrode wound around a winding core; and wherein the current collecting member is arranged on the upper portion of the electrode group; and wherein one of the positive electrode and the negative electrode is connected to the current collecting member; and wherein the lid unit is arranged on the current collecting member; and wherein one end portion of the electrically conductive lead is connected to the lid unit; and wherein other end portion of the electrically conductive lead is connected to the current collecting member; comprises: a process of joining the other end portion of the electrically conductive lead to the current collecting member; a process of pulling the one end portion of the electrically conductive lead out to the exterior of the cell container and joining it to the lid unit; and a process of swaging the lid unit to the cell container with the interposition of the insulation member, so as to seal up the interior of the cell container and isolate it from the exterior.

According to the 9th aspect of the present invention, in a method for manufacturing a secondary cell according to the 8th aspect, it is preferred that the process of pulling the one end portion of the electrically conductive lead out to the exterior of the cell container and joining it to the lid unit is a process of positioning the one end portion of the electrically conductive lead opposite relative to the central plane from the other end portion that is joined to the current collecting member, and moreover joining it to the lid unit so that a folded portion is created at one location partway therealong, or none.

According to the 10th aspect of the present invention, in a method for manufacturing a secondary cell according to the 8th aspect, it is preferred that the process of joining the other end portion of the electrically conductive lead to the current collecting member is performed by positioning the one end portion of the electrically conductive lead opposite relative to the central plane from the other end portion thereof, and the process of pulling the one end portion of the electrically conductive lead out to the exterior of the cell container and joining it to the lid unit is performed by pulling out the one end portion of the electrically conductive lead to a same side relative to the central plane as the other end portion of the electrically conductive lead, so that the folded portion of the electrically conductive lead is formed near the one end portion thereof which is joined to the lid unit.

According to the 11th aspect of the present invention, in a method for manufacturing a secondary cell according to the 8th aspect, it is preferred that the process of joining the other end portion of the electrically conductive lead to the current collecting member is performed by positioning the one end portion of the electrically conductive lead on a same side relative to the central plane as the other end portion thereof, and the process of pulling the one end portion of the electrically conductive lead out to the exterior of the cell container and joining it to the lid unit is performed by pulling out the one end portion of the electrically conductive lead to the same side relative to the central plane as the other end portion of the electrically conductive lead, so that the folded portion of the electrically conductive lead is formed near the other end portion thereof which is joined to the current collecting member.

According to the 12th aspect of the present invention, in a method for manufacturing a secondary cell according to the 8th aspect, it is preferred that the process of joining the other end portion of the electrically conductive lead to the electrode current collecting member is performed by positioning the one end portion of the electrically conductive lead opposite relative to the central plane from the other end portion thereof, and the process of pulling the one end portion of the electrically conductive lead out to the exterior of the cell container and joining it to the lid unit is performed by tilting the one end portion of the electrically conductive lead at an angle of less than 90° with respect to the junction surface where the other end portion of the electrically conductive lead is joined to the current collecting member, so that no such folded portion of the electrically conductive lead is formed.

According to the 13th aspect of the present invention, in a method for manufacturing a secondary cell according to the 8th aspect, it is preferred that the lid unit comprises a connection plate to which the one end portion of the electrically conductive lead is joined, a diaphragm that is joined to the connection plate, and a lid member that is swaged to the diaphragm; and the process of pulling the other end portion of the electrically conductive lead out to the exterior of the cell container and joining it to the lid unit is performed by laser welding by irradiation with a laser light.

According to the 14th aspect of the present invention, a method for manufacturing a secondary cell that comprises: a cell container receiving an electrode group, a current collecting member, a flexible electrically conductive lead and an electrolyte, and sealed with a lid unit via an insulation member; wherein the electrode group comprises a positive electrode and a negative electrode wound around a winding core; and wherein the current collecting member is arranged on the upper portion of the electrode group; and wherein one of the positive electrode and the negative electrode is connected to the current collecting member; and wherein the lid unit is arranged on the current collecting member; and wherein one end portion of the electrically conductive lead is connected to the lid unit; and wherein other end portion of the electrically conductive lead is connected to the current collecting member; comprising: a process of joining the other end portion of the electrically conductive lead to the current collecting member; a process of inserting a laser light guide member between the lid unit and the current collecting member; a process of joining the one end portion of the electrically conductive lead to the lid unit; and a process of swaging the lid unit to the cell container with the interposition of the insulation member, so as to seal up the interior of the cell container and isolate it from the exterior.

According to the 15th aspect of the present invention, in a method for manufacturing a secondary cell according to the 14th aspect, it is preferred that the process of joining the one end portion of the electrically conductive lead to the lid unit is a process that is performed after the process of joining the other end portion of the electrically conductive lead to the current collecting member, and includes a process of performing laser welding with the laser light guide member that is inserted between the lid unit and the current collecting member.

According to the 16th aspect of the present invention, in a method for manufacturing a secondary cell according to the 14th aspect, it is preferred that the process of joining the other end portion of the electrically conductive lead to the current collecting member is a process that is performed after the process of joining the one end portion of the electrically conductive lead to the lid unit, and includes a process of performing laser welding with the laser light guide member that is inserted between the lid unit and the current collecting member.

According to the 17th aspect of the present invention, in a secondary cell according to the 1st aspect, it is preferred that the electrically conductive lead has only one folded portion in the vicinity of the one end portion that is connected to the current collecting member.

According to the 18th aspect of the present invention, in a secondary cell according to the 1st aspect, it is preferred that the electrically conductive lead has only one folded portion in the vicinity of the other end portion that is connected to the current collecting member.

### BRIEF DESCRIPTION OF THE DRAWINGS

FIG. 1 is a vertical sectional view of a cylindrical secondary cell that is a first embodiment of the secondary cell of the present invention;

FIG. 2 is an exploded perspective view of the cylindrical secondary cell shown in FIG. 1;

FIG. 3 is a perspective view of an electrode group of FIG. 1, showing it in a partly cut away state so that its details are visible;

FIGS. 4A through 4C are sectional views of an electrically conductive lead, for explanation of a method of provisionally fixing this electrically conductive lead;

FIG. 5 is a sectional view for explanation of a process during the method of manufacture of the secondary cell shown in FIG. 1 according to the first embodiment of the present invention, and shows the principal portions involved;

FIG. 6 is a sectional view that shows the process for manufacturing this secondary cell, following the process shown in FIG. 5;

FIG. 7 is a sectional view that shows the process for manufacturing this secondary cell, following the process shown in FIG. 6;

FIG. 8 is a sectional view that shows the process for manufacturing this secondary cell, following the process shown in FIG. 7;

FIG. 9 is a sectional view for explanation of a process during the method of manufacture of a secondary cell according to the second embodiment of the present invention, and shows the principal portions involved;

FIG. 10 is a sectional view that shows the process for manufacturing this secondary cell shown in FIG. 9;

FIG. 11 is a sectional view of a secondary cell according to the third embodiment of the present invention, and shows the principal portions involved;

FIG. 12 is a sectional view that shows the process for manufacturing this secondary cell shown in FIG. 11;

FIG. 13 is a plan view of the cylindrical secondary cell of the present invention, for explanation of the definition of a central plane thereof;

FIG. 14 is a sectional view of a secondary cell according to the fourth embodiment of the present invention, and shows the principal portions involved; and

FIG. 15 is a sectional view that shows the next process for manufacturing this secondary cell shown in FIG. 14.

### DESCRIPTION OF THE PREFERRED EMBODIMENTS

### Embodiment 1

### Construction of the Cylindrical Secondary Cell

In the following, the secondary cell of this invention will be explained with reference to an embodiment in which the present invention is applied to a cylindrical lithium ion secondary cell, and with reference to the drawings.

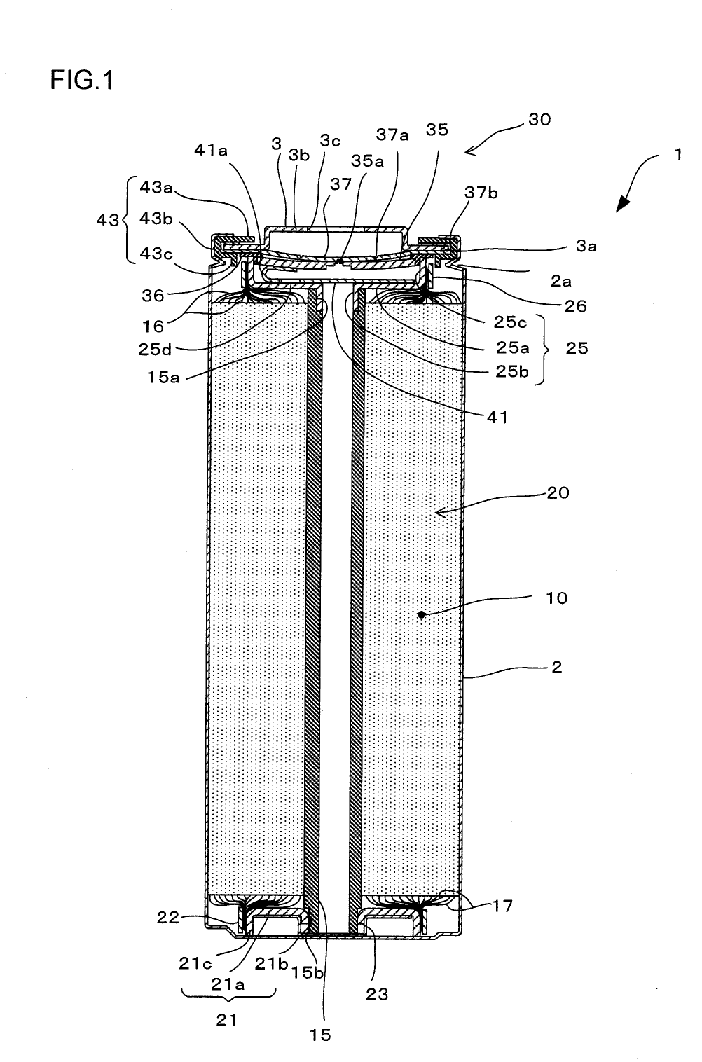

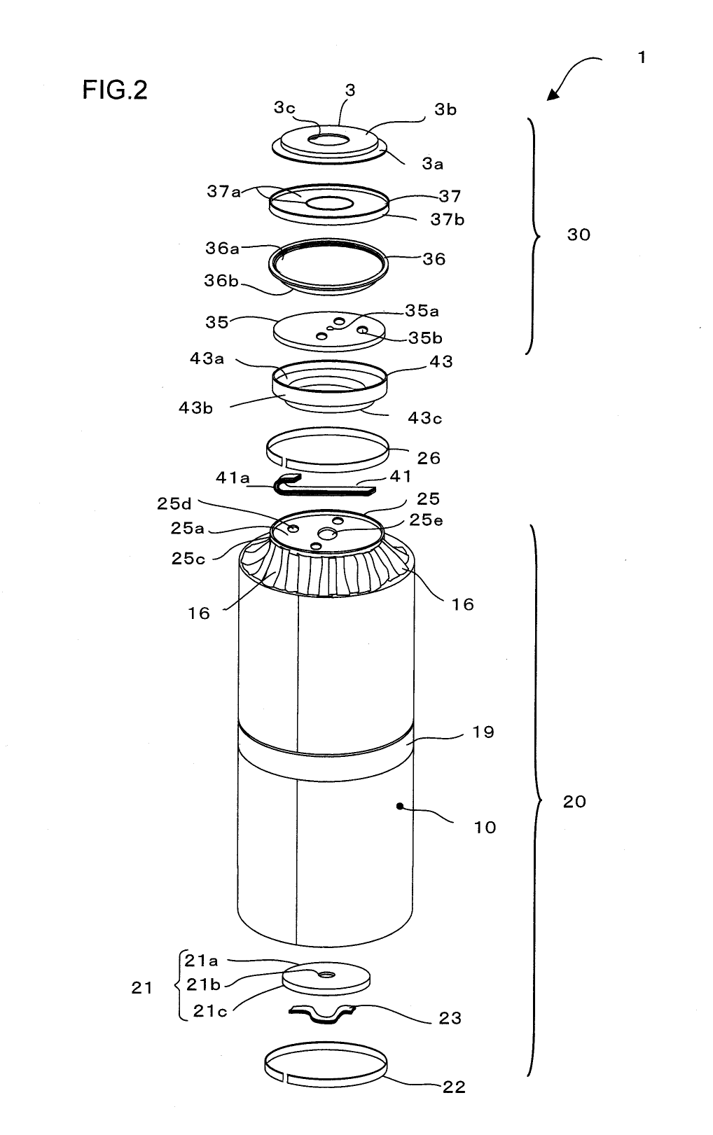

FIG. 1 is a vertical sectional view showing a first embodiment of the cylindrical secondary cell of the present invention, and FIG. 2 is an exploded perspective view of the cylindrical secondary cell shown in FIG. 1. The cylindrical secondary cell 1, for example, may be shaped as a cylinder that has an external shape of diameter 40 mm and a height of 100 mm. This cylindrical secondary cell 1 contains various structural members for generating electricity, which will be explained subsequently, in the interior of a cylindrical cell container 2 that has a bottom and that is capped by a hat shaped lid member 3. A groove 2a is formed to project towards the interior of this cylindrical cell container 2 with a bottom, at its upper end portion that is open.

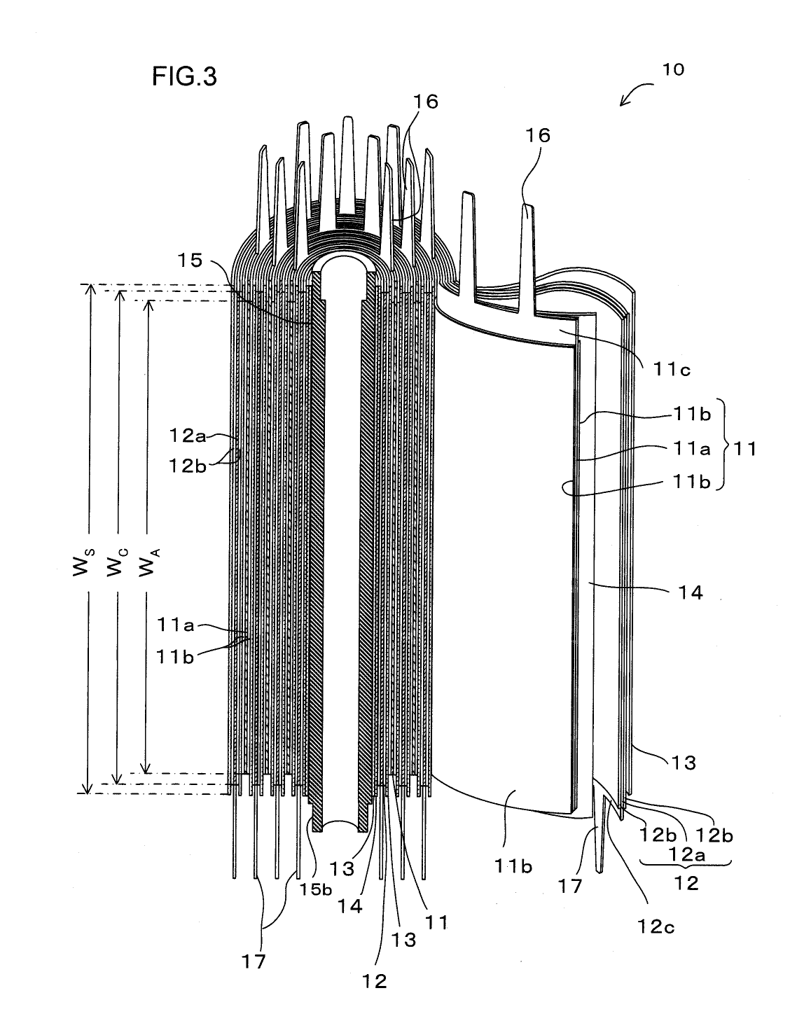

The reference symbol 10 denotes an electrode group that has a winding core 15 at its center, and a positive electrode, a negative electrode, and separators are wound around this winding core 15. FIG. 3 shows the detailed construction of the electrode group 10, and is a perspective view showing the electrode group 10 in a state with a portion thereof cut away. As shown in FIG. 3, this electrode group 10 has a structure in which a positive electrode 11, a negative electrode 12, and first and second separators 13 and 14 are wound around the outside of the winding core 15.

In this electrode group 10, at its innermost, a first separator 13 is wound around and contacts the outer circumferential surface of the winding core 15 that is formed as a hollow cylinder, and then, outside this first separator 13, a negative electrode 12, a second separator 14, and a positive electrode 11 are laminated in that order, and are wound up. And, inside the innermost winding of the negative electrode 12, the first separator 13 and the second separator 14 are wound a certain number of times (in FIG. 3, once). Furthermore, the negative electrode 12 appears on the outside, with the first separator 13 being wound around it. And, on the outside, the first separator 13 is held down with adhesive tape 19 (refer to FIG. 2).

The positive electrode 11 is made from aluminum foil and has an elongated shape, and includes a positive electrode sheet 11a and a processed positive electrode portion in which a positive electrode mixture is applied to form a layer 11b on both sides of this positive electrode sheet 11a. The upper side edge of the positive electrode sheet 11a along its longitudinal direction, to both sides of which the positive electrode mixture is not applied and along which the aluminum foil is accordingly exposed, constitutes a positive electrode mixture untreated portion 11c that is not treated with the positive electrode mixture. A large number of positive leads 16 are formed integrally at regular intervals upon this positive electrode mixture untreated portion 11c, and project upwards parallel to the winding core 15.

The positive electrode mixture consists of an active positive electrode material, an electrically conductive positive electrode material, and a positive electrode binder. The active positive electrode material is desirably a lithium metal oxide or a lithium transitional metal oxide. For example, lithium cobalt oxide, lithium manganate, lithium nickel oxide, or a compound lithium metal oxide (that includes two or more sorts of lithium metal oxides selected from the lithium metal oxides based on cobalt, nickel, and manganese) may be suggested. The electrically conductive positive electrode material is not particularly limited, provided that it is a substance that can assist transmission to the positive electrode of electrons that are generated in the positive electrode mixture by a lithium occlusion/emission reaction. As examples of a material for this electrically conductive positive electrode mixture, graphite or acetylene black or the like may be suggested. It should be noted that the above mentioned compound lithium metal oxide including transitional metal components may also itself be used as an electrically conductive positive electrode material, since it has electrical conductivity.

The positive electrode binder holds together the active positive electrode material and the electrically conductive positive electrode material, and also is capable of adhering together the layer of positive electrode mixture 11b and the positive electrode sheet 11a, and is not particularly limited, provide that it is not greatly deteriorated by contact with the non-aqueous electrolyte. As an example of a material for this positive electrode binder, polyvinylidene fluoride (PVDF) or fluorine-containing rubber or the like may be suggested. The method of making the positive electrode mixture layer 11b is not particularly limited, provided that it is a method of forming the layer 11b of positive electrode mixture upon the positive electrode. As an example of a method for making the positive electrode mixture 11b in the form of a layer, the method may be suggested of applying, onto the positive electrode sheet 11a, a solution in which the substances that make up the positive electrode mixture are dispersed.

As a method for applying the positive electrode mixture to the positive electrode sheet 11a, a roll coating method, a slit die coating method or the like may be suggested. As a solvent for the solution in which the positive electrode mixture is to be dispersed, for example, it may be added to N-methylpyrrolidone (NMP) or water or the like and kneaded into a slurry, that is then applied uniformly to both sides of an aluminum foil of thickness, for example, 20 μm; and, after drying, this may be cut up by stamping. The positive electrode mixture may be applied, for example, to a thickness of around 40 μm on each side. When the positive electrode sheet 11a is cut out by stamping, the positive leads 16 are formed integrally therewith at the same time. The lengths of all of the positive leads 16 are almost the same.

The negative electrode 12 is made from copper foil and has an elongated shape, and includes a negative electrode sheet 12a and a processed negative electrode portion in which a negative electrode mixture is applied to form a layer 12b on both sides of this negative electrode sheet 12a. Both sides of the lower side edge of the negative electrode sheet 12a along the longitudinal direction, to which the negative electrode mixture is not applied and along which the copper foil is accordingly exposed, constitute a negative electrode mixture untreated portion 12c that is not treated with the negative electrode mixture. A large number of negative leads 17 are formed integrally at regular intervals upon this negative electrode mixture untreated portion 12c, and project downwards in the direction opposite to that in which the positive leads 16 project.

The negative electrode mixture consists of an active negative electrode material, a negative electrode binder, and a thickener. This negative electrode mixture may also include an electrically conductive negative electrode material such as acetylene black or the like. It is desirable to use graphitic carbon as the active negative electrode material. By using graphitic carbon, it is possible to manufacture a lithium ion secondary cell that is suitable for a plug-in hybrid vehicle or electric vehicle, for which high capacity is demanded. The method for forming a layer of the negative electrode mixture 12b is not particularly limited, provided that it is a method that can form a layer of the negative electrode mixture 12b upon the negative electrode sheet 12a. As a method for applying the negative electrode mixture to the negative electrode sheet 12a, for example, the method may be suggested of applying upon the negative electrode sheet 12a a solution in which the constituent substances of the negative electrode mixture are dispersed. As the method for application, for example, a roll coating method, a slit die coating method or the like may be suggested.

As a method for applying the negative electrode mixture to the negative electrode sheet 12a, for example, N-methyl-2-pyrrolidone or water may be added to the negative electrode mixture as a dispersal solvent and kneaded into a slurry, that is then applied uniformly to both sides of a rolled copper foil of thickness, for example, 10 μm; and, after drying, this may be cut up by stamping. The negative electrode mixture may be applied, for example, to a thickness of around 40 μm on each side. When the negative electrode sheet 12a is cut out by stamping, the negative leads 17 are formed integrally therewith at the same time. The lengths of all of the negative leads 17 are almost the same.

If the widths of the first separator 13 and of the second separator 14 are termed WS, the width of the layer of negative electrode mixture 12b that is formed upon the negative electrode sheet 12a is termed W_{C}, and the width of the layer of positive electrode mixture 11b that is formed upon the positive electrode sheet 11a is termed W_{A}, then the manufacturing process is performed so that the following equation is satisfied:

W_{S}>W_{C}>W_{A} (refer to FIG. 3).

In other words, the width W_{C} of the layer of negative electrode mixture 12b is always greater than the width WA of the layer of positive electrode mixture 11b. This is done because, in the case of a lithium ion secondary cell, while the lithium that is the active positive electrode material is ionized and permeates the separator, if there is some portion on the negative electrode sheet 12a at which the layer of active negative electrode material 12b is not formed so that the negative electrode sheet 12a is exposed to the layer of positive electrode material 11b, then the lithium therein will be deposited upon the negative electrode sheet 12a, and this can cause an internal short circuit to occur. The first and second separators 13 and 14 may, for example, be made from perforated polyethylene of thickness 40 μm.

Referring to FIGS. 1 and 3, a stepped portion 15a with a diameter larger than the inner diameter of the winding core 15 is formed on the inner surface of the hollow cylindrical shaped winding core 15 at its upper end portion in the axial direction (the vertical direction in the drawing), and a positive electrode current collecting member 25 is pressed into this stepped portion 15a. This positive electrode current collecting member 25 may, for example, be made from aluminum, and includes a circular disk shaped base portion 25a, a lower cylindrical portion 25b that projects to face towards the winding core 15 at the surface of this base portion 25a facing the electrode group 10 and that is pressed into the inner surface of the stepped portion 15a, and an upper cylindrical portion 25c that projects out towards the lid member 3 at its outer peripheral edge. An aperture 25d (refer to FIG. 2) is formed at the base portion 25a of the positive electrode current collecting member 25, for allowing the escape of gas generated in the interior of the cell. Furthermore, an aperture 25e (refer to FIG. 2) is formed in the positive electrode current collecting member 25; the function of this aperture 25e will be described hereinafter. It should be noted that the winding core 15 is made of a material of a type that isolates electrically between the positive electrode current collecting member 25 and the negative electrode current collecting member 21, and that also maintains and enhances the axial rigidity of the cell. In the present embodiment, for example, a glass-fiber reinforced polypropylene is employed as the material for the winding core 15.

All of the positive leads 16 of the positive electrode sheet 11a are welded to the upper cylindrical portion 25c of the positive electrode current collecting member 25. In this case, as shown in FIG. 2, the positive leads 16 are overlapped over one another and joined upon the upper cylindrical portion 25c of the positive electrode current collecting member 25. Since each of these positive leads 16 is very thin, accordingly it is not possible for a large electrical current to be taken out by just one of them. Due to this, the large number of positive leads 16 are formed at predetermined intervals over the total length of the upper edge of the positive electrode sheet 11a from the start of its winding onto the winding core 15 to the end of that winding.

Since the positive electrode current collecting member 25 is oxidized by the electrolyte, its reliability can be enhanced by making it from aluminum. When the aluminum on the front surface is exposed by any type of processing, immediately a coating of aluminum oxide is formed upon that front surface, so that it is possible for oxidization by the electrolyte to be prevented due to this layer of aluminum oxide. Moreover, by making the positive electrode current collecting member 25 from aluminum, it becomes possible to weld the positive leads 16 of the positive electrode sheet 11a thereto by ultrasonic welding or spot welding or the like.

A stepped portion 15b whose outer diameter is smaller than the outer diameter of the winding core 15 is formed upon the external peripheral surface of the lower end portion of the winding core 15, and a negative electrode current collecting member 21 is pressed over this stepped portion 15b and thereby fixed thereto. This negative electrode current collecting member 21 may, for example, be made from copper, and is formed with a circular disk shaped portion 21a and with an opening portion 21b that is formed in the disk shaped portion 21a and is pressed over the stepped portion 15b of the winding core 15; and, on its outer peripheral edge, an external circumferential cylindrical portion 21c is formed so as to project facing downwards towards the bottom portion of the cell container 2.

All of the negative leads 17 of the negative electrode sheet 12a are welded to the external circumferential cylindrical portion 21c of the negative electrode current collecting member 21 by ultrasonic welding or the like. Since each of these negative leads 17 is very thin, in order to take out a large electrical current, a large number of them are formed over the total length of the lower edge of the negative electrode sheet 12a from the start of its winding onto the winding core 15 to the end of its winding, at predetermined intervals.

The negative leads 17 of the negative electrode sheet 12a and the annular pressure member 22 are welded to the external periphery of the external circumferential cylindrical portion 21c of the negative electrode current collecting member 21. The large number of negative leads 17 are closely clamped against the external peripheral surface of the external circumferential cylindrical portion 21c of the negative electrode current collecting member 21, the pressure member 22 is wound over the externally oriented surfaces of the negative leads 17 and temporarily fixed there, and then they are all welded together in that state.

A negative electrode power lead 23 that is made from copper is welded to the lower surface of the negative electrode current collecting member 21. This negative electrode power lead 23 is welded to the bottom portion of the cell container 2. The cell container 2 may, for example, be made from carbon steel of thickness 0.5 mm, and its surface is processed by nickel plating. By using this type of material, it is possible to weld the negative electrode power lead 23 to the cell container 2 by resistance welding or the like.

The aperture 25e that is formed in the positive electrode current collecting member 25 is for insertion of an electrode rod (not shown in the drawings) for welding the negative electrode power lead 23 to the cell container 2. In more detail, a welding electrode rod is inserted through the aperture 25e formed in the positive electrode current collecting member 25 into the hollow central axis of the winding core 15, and its tip end portion presses the negative electrode power lead 23 against the inner surface of the bottom portion of the cell container 2, so that it can be welded by resistance welding.

The positive leads 16 of the positive electrode sheet 11a and an annular pressure member 26 are welded to the external periphery of the upper cylindrical portion 25c of the positive electrode current collecting member 25. The large number of positive leads 16 are closely clamped against the external peripheral surface of the upper cylindrical portion 25c of the positive electrode current collecting member 25, the pressure member 26 is wound over the externally oriented surfaces of the positive leads 16 and temporarily fixed there, and then they are all welded together in that state.

By the large number of positive leads 16 being welded to the positive electrode current collecting member 25 and the large number of negative leads 17 being welded to the negative electrode current collecting member 21, the positive electrode current collecting member 25, the negative electrode current collecting member 21, and the electrode group 10 are integrated together into the generating unit 20 (refer to FIG. 2). However in FIG. 2, for the convenience of illustration, the negative electrode current collecting member 21, the pressure member 22, and the negative electrode power lead 23 are shown as separated from the generating unit 20.

Furthermore, the other end portion 41c of a flexible lead plate 41 (i.e. an electrically conductive lead) that is made by laminating together a plurality of layers of aluminum foil is joined to the upper surface of the base portion 25a of the positive electrode current collecting member 25 by laser welding. Since this lead plate 41 is made by laminating together and integrating a plurality of layers of aluminum foil, accordingly it is capable of carrying a large electrical current, and moreover it is endowed with flexibility. In other words, while it is necessary to make the thickness of the connection member (i.e. the lead plate) great in order for it to conduct a high electrical current, if it were to be made from a single metallic plate, its rigidity would become high, and it would lose its flexibility. Accordingly this lead plate 41 is made by laminating together a large number of sheets of aluminum foil each of which is of low thickness, thus preserving its flexibility. The thickness of the lead plate 41 may, for example, be 0.5 mm, and it may be made by laminating together 5 sheets of aluminum foil each of thickness 0.1 mm.

A lid unit 30 is disposed above the upper cylindrical portion 25c of the positive electrode current collecting member 25. This lid unit 30 includes an insulation plate 36 formed in the shape of an annulus and having a central opening portion 36a, a connection plate 35 that is fitted into the central opening portion 36a of the insulation plate 36, a diaphragm 37 that is welded to the connection plate 35, and a lid member 3 that is fixed by swaging to the diaphragm 37.

The insulation plate 36, that is made from an insulating resin material, has the opening portion 36a, thus being formed as an annulus, and is mounted above the upper cylindrical portion 25c of the positive electrode current collecting member 25. The insulation plate 36 also has a tubular portion 36b that projects downward from the periphery of the opening portion 36a (refer to FIG. 2). The connection plate 35 is fitted into the opening portion 36a of the insulation plate 36. The one end portion 41b of the flexible lead plate 41 is joined by laser welding to the lower surface of the connection plate 35.

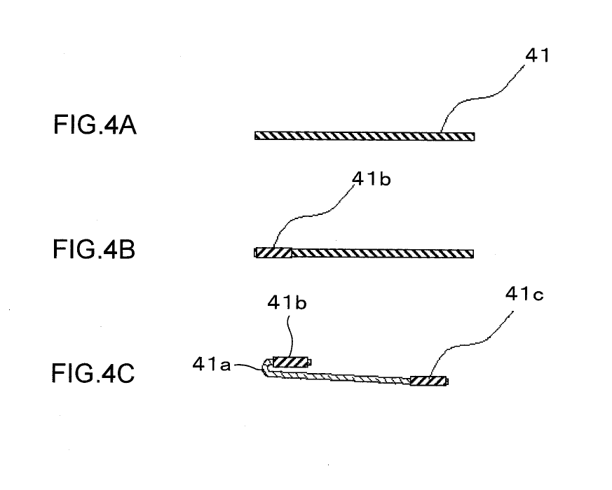

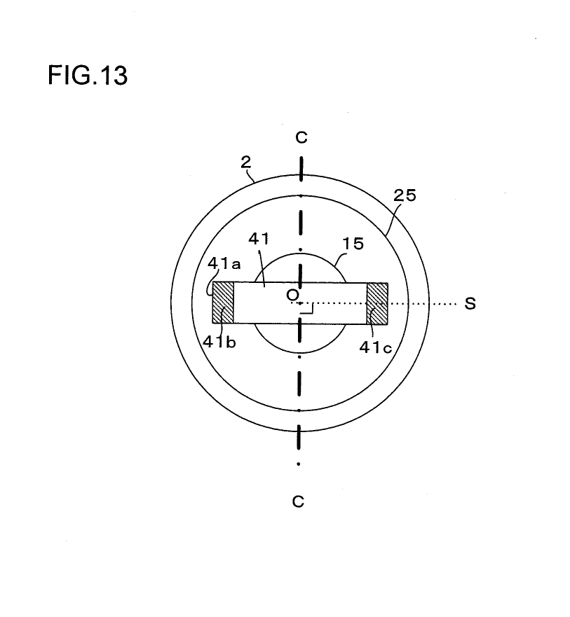

As described above, the other end portion 41c of the lead plate 41 is joined to the upper surface of the base portion 25a of the positive electrode current collecting member 25, and the lead plate 41 extends therefrom and protrudes to the opposite side with respect to the winding core 15. And the lead plate 41 is then folded through 180° at a folding portion 41a into a U-shape, and its one end portion 41b is joined to the connection plate 35 at a position on the opposite side of a certain central plane from its abovementioned other end portion 41c. Moreover, the surface of the lead plate 41 that is joined to the positive electrode current collecting member 25 at its one end other end portion 41c is and the surface thereof that is joined to the connection plate 35 at its one end portion 41b are of the same side of the lead plate 41 (see FIG. 4). FIG. 13 is a plan view of this cylindrical secondary cell, for explanation of the definition of this central plane thereof. This central plane is the plane C-C that includes the central axis O of the winding core 15 and that is orthogonal to the plane S-O that includes the other end portion 41c of the lead plate 41 and the central axis O of the winding core 15. Here, the plane S-O and the plane C-C are planes that include the central axis O of the winding core 15 and that project perpendicular to the drawing paper in FIG. 13. In other words, since the other end portion 41c of the lead plate 41 and its one end portion 41b are, in plan view, symmetrically positioned on opposite sides of the central plane C-C, and these end portions 41c and 41b are respectively joined to the positive electrode current collecting member 25 and to the connection plate 35, accordingly the length of the lead plate 41 becomes shorter, as compared to a construction in which the one end portion 41b is returned to the same side of the central plane as the other end portion 41c. It should be understood that the methods by which the other end portion 41c and the one end portion 41b are joined to the positive electrode current collecting member 25 and to the connection plate 35 respectively will be described in detail hereinafter.

The connection plate 35 is made from aluminum alloy, and is almost uniform all over except for its central portion; however, its central portion is bent downwards slightly into a lower position, so that it has an almost dished shape. The thickness of this connection plate 35 may be, for example, around 1 mm. A projecting portion 35a that is made in a shallow dome shape is formed at the center of the connection plate 35, and a plurality of apertures 35b (refer to FIG. 2) are formed around the projecting portion 35a. These apertures 35b have the function of allowing escape of gas generated in the interior of the cell.

This projecting portion 35a of the connecting plate 35 is joined to the central portion of the bottom surface of the diaphragm 37 by low resistance welding or friction stir welding. This diaphragm 37 is made from aluminum alloy, and a circular groove 37a is provided around the central portion of the diaphragm 37. The groove 37a is made by squashing the upper surface of the diaphragm 37 into a letter-V shape by pressing with a die, so that the portion remaining is very thin. The diaphragm 37 is provided in order to ensure the safety of the cell: if the pressure internal to the cell rises, then at a first stage this diaphragm 37 bends somewhat upwards, and its junction to the projecting portion 35a of the connection plate 35 becomes detached and it separates from the connection plate 35, so that its electrical continuity with the connection plate 35 is broken. If the pressure internal to the cell still continues to rise, then at a second stage the groove 37a ruptures, and this functions to vent the gas internal to the cell and reduce the internal pressure.

At its peripheral portion, the diaphragm 37 is fixed to a peripheral portion 3a of the lid member 3. As shown in FIG. 2, the diaphragm 37 has a side portion 37b at its edge portion that, initially, stands up vertically towards the lid member 3. The lid member 3 is placed within this side portion 37b, and then, by a swaging process, the side portion 37b is bent over towards the upper surface of the lid member 3, and clamps the lid member 3 in position.

The lid member 3 is made from a ferrous metal such as carbon steel or the like and is nickel plated, and has a hat shape that includes a circular disk shaped peripheral flange part 3a contacted to the diaphragm 37 and a top portion 3b that projects upwards from this peripheral part 3a. An aperture 3c is formed in the top portion 3b. This aperture 3c is for allowing gas that has been generated internally to the cell to vent and escape to the exterior, when the pressure of this gas internal to the cell has ruptured the diaphragm 37 as described above. It should be understood that, if the lid member is made from a ferrous metal, then, when this cylindrical secondary cell is to be joined in series with another cylindrical secondary cell of the same type that is also made from a ferrous metal, it is possible to join them together by spot welding.

A gasket 43 is provided for covering the side portion 37b of the diaphragm 37 and its peripheral portion. Initially, as shown in FIG. 2, this gasket 43 has a shape that includes an annular base portion 43a, an external peripheral wall portion 43b that is formed on the outer circumferential edge of this annular base portion 43a so as to stand almost vertically upwards, and a cylinder portion 43c that is formed so as to drop almost vertically downwards from the inner circumferential edge of the base portion 43a.

And swage processing is performed by pressing or the like, so as to bend down the upper edge portion of the cell container 2 along with the external peripheral wall portion of the gasket 43, and thereby the diaphragm 37 and the lid member 3 are pressed into contact along the axial direction by the base portion 43a and the external peripheral wall portion 43b of the gasket 43. Due to this, the lid member 3 and the diaphragm 37 are fixed to the cell container 2 with the interposition of the gasket 43.

A predetermined amount of a non-aqueous electrolyte is injected into the interior of the cell container 2. A solution of a lithium salt dissolved in a carbonate series solvent is a preferred example of such a non-aqueous electrolyte that may be used. Examples that may be cited of lithium salts are lithium hexafluorophosphate (LiPF₆), lithium tetrafluoroborate (LiBF₄), and so on. Furthermore, examples that may be cited of carbonate series solvents are ethylene carbonate (EC), dimethyl carbonate (DMC), propylene carbonate (PC), methyl-ethyl carbonate (MEC), mixtures of two or more solvents selected from the above, and so on.

Next, an example will be explained of a method of manufacturing the cylindrical secondary cell shown in FIGS. 1 through 3, that is a first embodiment of the present invention.

Method of Manufacturing this Cylindrical Secondary Cell

### Manufacturing the Electrode Group

First, the electrode group 10 is manufactured. A positive electrode 11 is made by forming a positive electrode mixture layer 11b and a positive electrode mixture untreated portion 11c on both sides of a positive electrode sheet 11a, and a large number of positive leads 16 are formed integrally with the positive electrode sheet 11a. Moreover, a negative electrode 12 is made by forming a negative electrode mixture layer 12b and a negative electrode mixture untreated portion 12c on both sides of a negative electrode sheet 12a, and a large number of negative leads 17 are formed integrally with the negative electrode sheet 12a.

Next, the innermost edge portions of a first separator 13 and a second separator 14, in other words the starting edge portions of these separators where winding is to commence, are welded to a winding core 15. Next, the first separator 13 and the second separator 14 are wound up through about one turn upon the winding core 15, the starting edge portion of the negative electrode 12 is inserted between the second separator 14 and the first separator 13 upon the winding core 15, and the winding core 15 is rotated through a predetermined angle so as further to wind up the second separator 14, the first separator 13, and the negative electrode 12 somewhat. And next, the starting edge portion of the positive electrode 11 is inserted between the second separator 14 and the first separator 13. And in this state the winding core is rotated through a predetermined number of turns, so as to take up the first separator 13, the second separator 14, the positive electrode 11, and the negative electrode 12 completely; and then finally, on the outside, the first separator 13 is held down with adhesive tape, whereby the manufacture of this electrode group 10 is completed.

Manufacturing the Generating Unit

Next, a negative electrode current collecting member 21 is fitted to the lower portion of the winding core 15 of this electrode group 10 that has been manufactured by the method described above. This fitting of the negative electrode current collecting member 21 is implemented by fitting it into the stepped portion 15b provided on the lower end portion of the winding core 15 into the aperture 21b that is formed in the negative electrode current collecting member 21. Next, the negative leads 17 are formed to closely contact to the external circumference of the cylinder portion 21c of the negative electrode current collecting member 21, and then the pressure member 22 is fitted over the external circumference of the negative electrode current collecting member 21, i.e. over the negative leads 17. And the negative electrode current collecting member 21, the negative leads 17, and the pressure member 22 are then welded together by ultrasonic welding or the like. And next, the negative electrode power lead 23 is welded to the negative electrode current collecting member 21, so as to straddle the lower end surface of the winding core 15 and the negative electrode current collecting member 21.

Next, the lower cylindrical portion 25b of the positive electrode current collecting member 25, to which the other end portion 41c of the lead plate 41 has been welded as described above, is fitted into the stepped portion 15a that is provided in the upper end of the winding core 15. In this state, the positive leads 16 are formed to closely contact to the external circumference of the upper cylindrical portion 25c of the positive electrode current collecting member 25, and then the pressure member 26 is fitted over the external circumference of the positive electrode current collecting member 25, i.e. over the positive leads 16. And the positive electrode current collecting member 25, the positive leads 16, and the pressure member 26 are then welded together by ultrasonic welding or the like. By doing this, the generating unit 20 shown in FIG. 2 is manufactured.

Loading the Generating Unit into the Cell Container

Next, the generating unit 20 that has been manufactured according to the process described above is loaded into a hollow cylindrical element that has a bottom but no top, and that is made from metal and is of a size capable of containing the generating unit 20. This cylindrical member with a bottom will become the cell container 2. In the following, for simplicity of explanation, this cylindrical member having a bottom will therefore be referred to as the cell container 2.

Connecting the Negative Electrode

With the generating unit 20 loaded into the cell container 2, the negative electrode power lead 22 is welded to the bottom of the cell container 2 by resistance welding or the like. Although this process is not shown in the figure, at this time, an electrode rod is inserted through the aperture 25e of the positive electrode current collecting member 25, is passed down the hollow portion of the winding core 15, and is pressed against the negative electrode power lead 23 so as to push it against the bottom portion of the cell container 2, so that resistance welding can be performed. Next, a portion of the upper end of the cell container 2 is processed by being pushed radially inward, so that a portion of the cell container outer surface is formed into the groove 2a that is almost V-shaped. This groove 2a on the cell container 2 is formed so as to be positioned at the upper end portion of the generating unit 20, or, to put it in another manner, is formed in the vicinity of the upper end of the positive electrode current collecting member 25.

Injection of the Electrolyte

Next, a predetermined amount of a suitable non-aqueous electrolyte is injected into the interior of the cell container 2 in which the generating unit 20 is contained. For this non-aqueous electrolyte, for example, as described above, a solution of a lithium salt dissolved in a carbonate series solvent may be used.

Manufacture of the Lid Unit

On the other hand, the lid unit 30 is manufactured separately from the process described above of assembling the cell container 2. As previously described, this lid unit 30 is made from the insulation plate 36, the connection plate 35 that is fitted into the opening portion 36a of the insulation plate 36, the diaphragm 37 that is welded to the connection plate 35, and the lid member 3 that is fixed by swaging to the diaphragm 37.

In the manufacture of this lid unit 30, first, the lid member 3 is fixed to the diaphragm 37. This fixing together of the diaphragm 37 and the lid member 3 is performed by swaging or the like. Since initially the side wall 37b of the diaphragm 37 is formed as perpendicular to its base portion 37a, as shown in FIG. 2, accordingly the peripheral part 3a of the lid member 3 can be fitted in within the side wall 37b of the diaphragm 37. And then the side wall 37b of the diaphragm 37 is deformed by being pressed inwards or the like, so that it is pressed into contact with and covers the upper and lower surfaces of the peripheral part of the lid member 3 as well as its external circumferential edge.

Moreover, the connection plate 35 is fitted into the opening portion 36a of the insulation plate 36. Next, the projecting portion 35a of the connection plate 35 is welded to the bottom surface of the diaphragm 37 to which the lid member 3 is fixed. As the method of welding in this case, resistance welding or friction stir welding may be employed. By welding the connection plate 35 and the diaphragm 37 together, the lid member 3, to which the connection plate 35 and the insulation plate 36 into which the connection plate 35 is fitted are fixed, is integrated with the connection plate 35 and the diaphragm 37.

Joining the Positive Electrode

Next, the electrode group 10 and the lid unit 30 are electrically connected together. However, before this, the gasket 43 is mounted above the groove 2a of the cell container 2. In this state, as shown in FIG. 2, the gasket 43 has a structure that includes an annular base portion 43a, and, above this annular base portion 43a, an external peripheral wall portion 43b that is perpendicular to the base portion 43a. With this construction, the gasket 43 is held inside the cell container 2, above the groove 2a. This gasket 43 is made from rubber, although this is not intended to be limitative; an example of one possible material that may be employed is ethylene propylene copolymer (EPDM). Furthermore, for example, the cell container 2 may be made of carbon steel of thickness 0.5 mm and its external diameter may be 40 mm, while the thickness of the gasket 43 may be around 1.0 mm.

And the other end portion 41c of the lead plate 41 is joined by ultrasonic welding or the like to the upper surface of the base portion 25a of the positive electrode current collecting member 25. Since in this case, as described above, the lead plate 41 is made by laminating together a plurality of layers of aluminum foil or the like, accordingly, when the end portions are respectively bundled by end treatment, the laminated aluminum foils are prevented from separation, and the lead plate 41 can be positioned simply and easily. FIGS. 4(a) through 4(c) are sectional views of the lead plate 41 for explanation of this end treatment process.

First, as shown in FIG. 4(a), for example, around five layers of aluminum alloy foil of approximate width 6 mm, approximate thickness 0.1 mm, and approximate length 30 mm are laminated together.

Then, as shown in FIG. 4(b), at one end of this layered aluminum foil lead plate member 41, the layers thereof are joined together over a range of around 4 mm in length and around 4 mm in width by a method such as ultrasonic welding or the like, so as to form a treated one end portion 41b.

And then, as shown in FIG. 4(c), a folding portion 41a is formed at the portion close to the one end portion 41b, being bent back in the shape of a letter-U. And then, at the other end of the lead plate member 41, the other end portion 41c is treated by joining the layers thereof together over a range of around 4 mm in length and around 4 mm in width by a method such as ultrasonic welding or the like.

The welding for performing this end treatment is performed at an intensity that is sufficient to hold together the thin layers of aluminum alloy foil just for preventing from separation. As one example, ultrasonic welding may be performed at around 10 J/s. This end treatment is not essential. Moreover, for example, even if this end treatment is performed, it would also be acceptable only to perform it at one end of the plate member 41 but not at the other, rather than at both ends as described above.

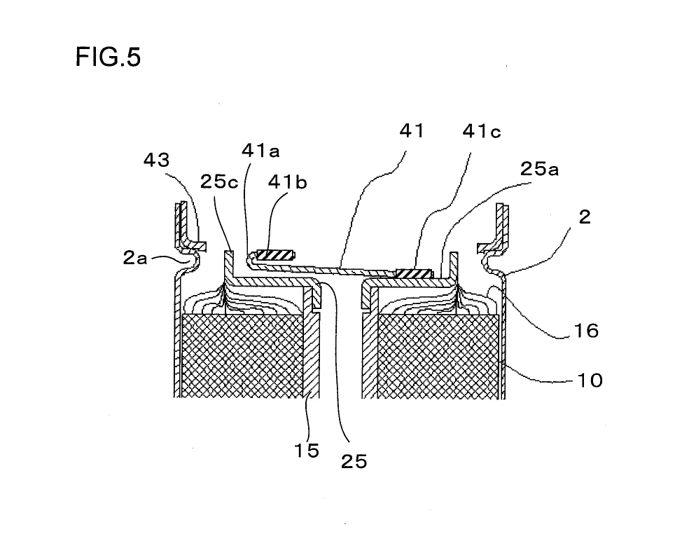

FIGS. 5 through 8 are cross sectional views for explanation of the method for electrically connecting together the positive electrode current collecting member 25 and the lid unit 30 with the lead plate 41, and show the principal elements involved.

First, the treated other end portion 41c at the other end of the lead plate 41 that has been formed as described above is joined by ultrasonic welding or the like to the upper surface of the base portion 25a of the positive electrode current collecting member 25 that is contained in the cell container 2. In this case, as shown in FIG. 5, the junction at this other end portion 41c is established in the state in which the treated portion at the one end portion 41b is disposed on the other side of the winding core thereto, or, to put it in another manner, in the state in which the one end portion 41b is positioned on the opposite side of the cell container 2 with respect to the central plane defined above. In this state, the folding portion 41a and the one end portion 41b of the lead plate 41 are positioned within the upper cylindrical portion 25c of the positive electrode current collecting member 25 that is received within the container 2.

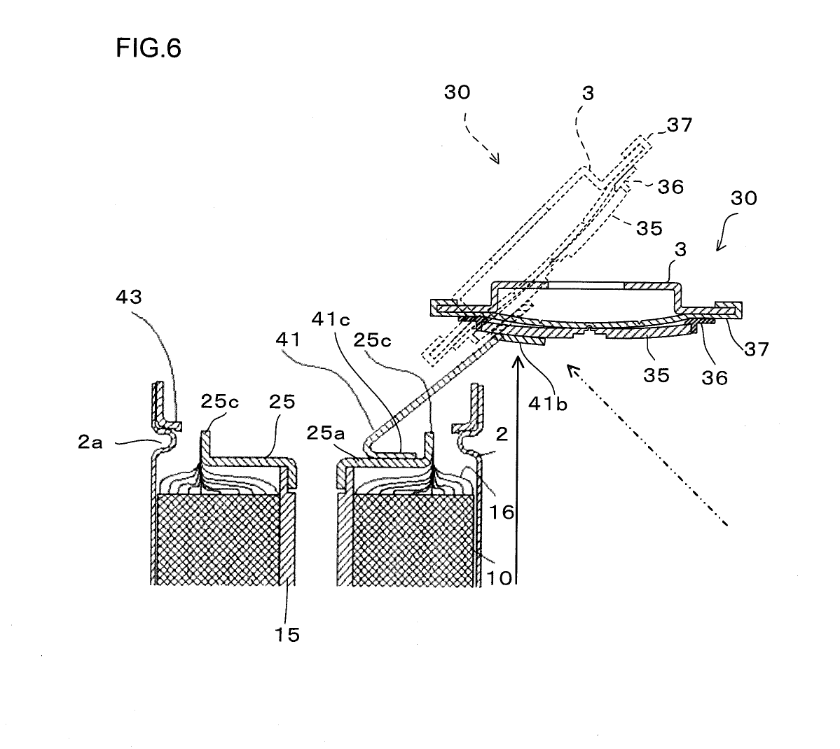

Next, as shown in FIG. 6, the one end portion 41b of the lead plate 41 that is provisionally fixed is rotated around the portion close to the other end portion 41c that is attached to the positive electrode current collecting member 25 as an central axis in the clockwise direction in FIG. 6, past the central axis of the winding core 15 until it reaches the exterior of the cell container 2. In this state, the one end portion 41b and the other end portion 41c of the lead plate 41 are now positioned on the same side of the central plane. Furthermore, the one end portion 41b of the lead plate 41 is at a position that is higher than the upper end of the cell container 2, and moreover is pulled out away from the central axis of the cell container 2 to a position that is further out than its side wall.

In this state, the one end portion 41b of the lead plate 41 is now joined to the lid unit 30 described above, as follows.

The connection plate 35 of the lid unit 30 is held by a holding jig not shown in the figures in the state in which it is contacted against the one end portion 41b of the lead plate 41, and then a laser light is irradiated in the direction shown by the solid arrow, so that laser welding is performed. In this case, the junction surface of the lead plate 41 by which the one end portion 41b is joined to the connection plate 35 of the lid unit 30, and its junction surface by which the other end portion 41c is joined to the base portion 25a of the positive electrode current collecting member 25, are of the same side of the lead plate 41 (see. As one example of the welding conditions, welding may be performed at 2000 W for approximately one second.

Since, in this embodiment, the laser welding is performed while the one end portion 41b of the lead plate 41 is located at a position where it is pulled out to the exterior, past the side surface of the cell container 2, accordingly it is possible to prevent any minute metallic particles of foreign matter that are generated during the welding process from getting into the cell container 2. If during the laser welding process the opening at the top of the cell container 2 is also covered by a shielding member, then it becomes possible even more reliably to prevent minute metallic particles of foreign matter generated during the welding process from getting into the interior of the cell container 2.

Furthermore, since the portions of the lead plate 41 other than the one end portion 41b and the other end portion 41c that are welded to the connection plate 35 and to the positive electrode current collecting member 25 respectively are not welded, accordingly due to vibration they may possibly come into contact with or come away from the positive electrode current collecting member 25 or the connection plate 35, through which a short circuit may be created. A current may flow concentrated at such a point of short circuit, and heat may be generated at such point.

In order to prevent this, it is desirable to form an insulating layer over the portions of the lead plate 41 other than its one end portion 41b and its other end portion 41c by some method such as winding a layer of adhesive film over them, or painting them with an insulating paint or the like. This formation of an insulating layer should be performed before the processes of joining the lead plate 41 to the positive electrode current collecting member 25 and the connection plate 35.

It should be understood that, in FIG. 6, it is shown that the laser welding of the one end portion 41b of the lead plate 41 is performed in the state in which the connection plate 35 of the lid unit 30 is held almost perpendicular to the side of the cell container 2. However, it would also be possible to irradiate the laser light against the one end portion 41b of the lead plate 41 with the lid unit 30 rotated somewhat in the anti-clockwise direction from its state in which the connection plate is in a horizontally positioned state, as for example shown by the double dotted broken arrow. Any position will be acceptable, provided that the laser light irradiation can be performed in an unobstructed path with the one end portion 41b of the lead plate 41 and the connection plate 35 of the lid unit 30 being held exterior to the cell container 2.

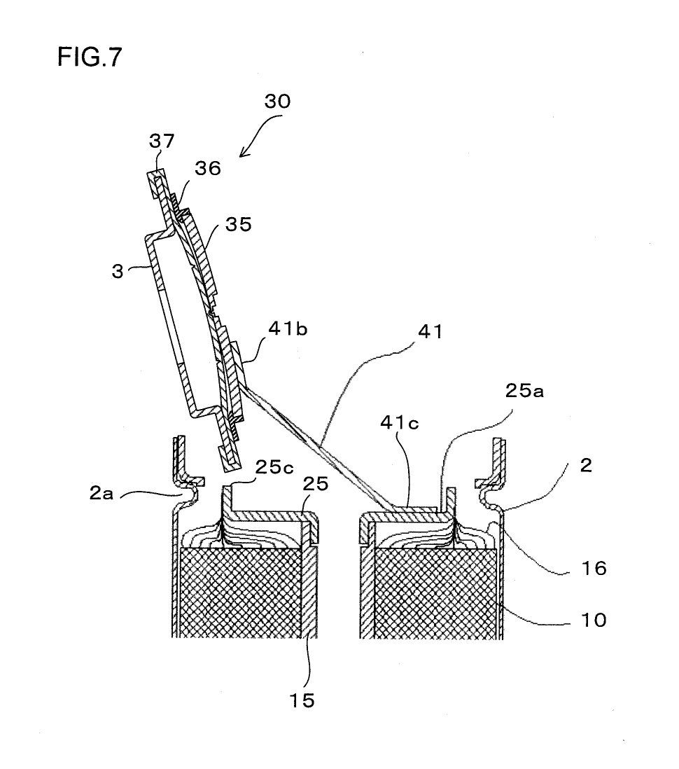

Next, as shown in FIG. 7, the lid unit 30, to which the one end portion 41b of the lead plate 41 has now been joined, together with the lead plate 41, is rotated in the anti-clockwise direction in FIG. 7 to a position past the central axis of the winding core 15, around the portion close to the other end portion 41c of the lead plate 41 that is welded to the base portion 25a of the positive electrode current collecting member 25 as an central axis. In this case, in order to ensure that no damage to the lead plate 41 takes place, and in order to ensure that the other end portion 41c and the one end portion 41b of the lead plate do not become detached, this rotation should be performed while controlling the tension force that is applied to be, for example, 1 N or less. And, from the state shown in FIG. 7, the lid unit 30 (only) is rotated in the clockwise direction in that figure around the portion close to one end portion 41b of the lead plate 41 that is welded to the connection plate 35 of the lid unit 30 as an central axis, so that the upper surface of the lid member 3 now becomes almost horizontal.

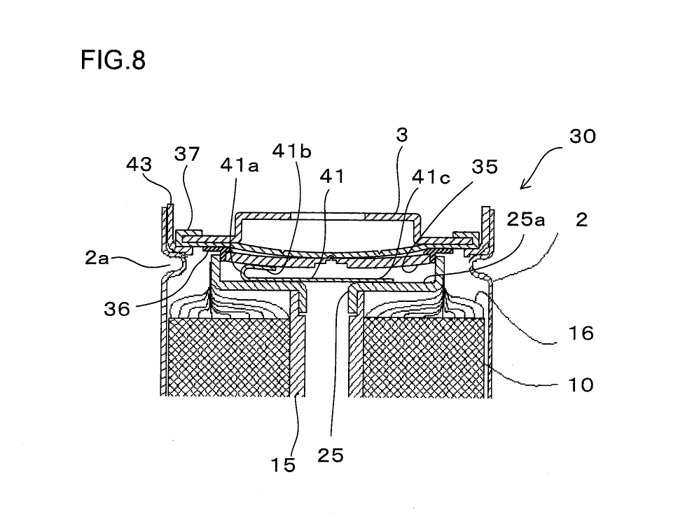

And, in the state in which the upper surface of the lid member 3 of the lid unit 30 is almost horizontal, as shown in FIG. 8, the peripheral portion of the diaphragm 37 of the lid unit 30 is mounted above the gasket 43.

In this manner, after the one end portion 41b of the lead plate 41 has been rotated to the opposite side of the central plane as shown in FIG. 7, along with the lid unit 30, then the lid unit 30 is rotated so that it becomes horizontal, as shown in FIG. 8. Due to this, the folding portion 41a is re-formed at the base of the one end portion 41b of the lead plate 41, as shown in FIG. 8.

Sealing the Cell Container

In the state described above, next, the diaphragm 37 is fixed to the cell container with the interposition of the gasket 43 by so called swaging processing, in which the portion of the cell container 2 between the groove 2a and its upper end edge is pressed and compressed,

By doing this, the lid unit 30 is fixed to the cell container 2 with the interposition of the gasket 43 in the state with the positive electrode current collecting member 25 and the lid member 3 being connected together via the lead plate 41 in an electrically conductive state, and thereby the manufacture of the cylindrical secondary cell 1 shown in FIG. 1 is completed.

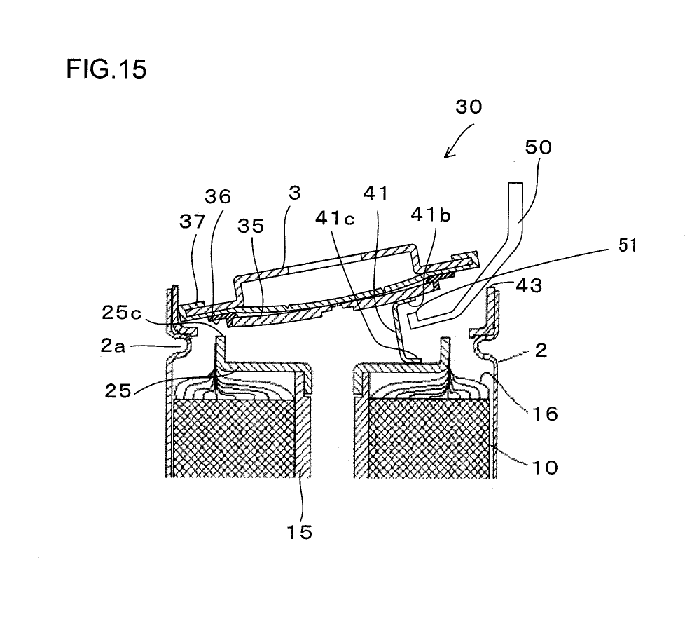

As described above, according to the secondary cell of the present invention and the method of manufacture thereof, on the positive electrode current collecting member 25 and the lid unit 30, the point where the one end portion 41b of the lead plate 41 is joined to the lid unit 30 is positioned on the opposite side of the central plane from the other end portion 41c that is joined to the positive electrode current collecting member 25. Moreover, in this construction, they are only connected together by this one lead plate 41 that has the folding portion 41a at one location partway along it. Due to this, it is possible to make the length of the lead plate 41 short. Moreover since the one end portion 41b of the lead plate 41, whose other end portion 41c is joined to the positive electrode current collecting member 25, is pulled out to the exterior of the cell container 2 and is joined to the lid unit 30 in this state, accordingly it is possible to establish the electrical connection between the positive electrode current collecting member 25 and the lid unit 30 by welding, even if the length of the lead plate 41 is short. In this case, since the junction between the lead plate 41 and the lid unit 30 is made by laser welding, accordingly it is possible to perform the welding even if the distance by which the lid unit 30 is pulled out away from the cell container 2 is shorter, and moreover the level of workability is still acceptable (see for example FIG. 15). Furthermore, since an insulating layer is provided over the surfaces of the remainder portions of the lead plate 41 other than its junction portions, accordingly, even if due to vibration or the like the lead plate 41 should come into contact with the other electrode members, it is possible to prevent diversion of the electrical current or concentration of the electrical current at the point of contact, so that it is possible to prevent from heat generation through such a contact.

### Embodiment 2

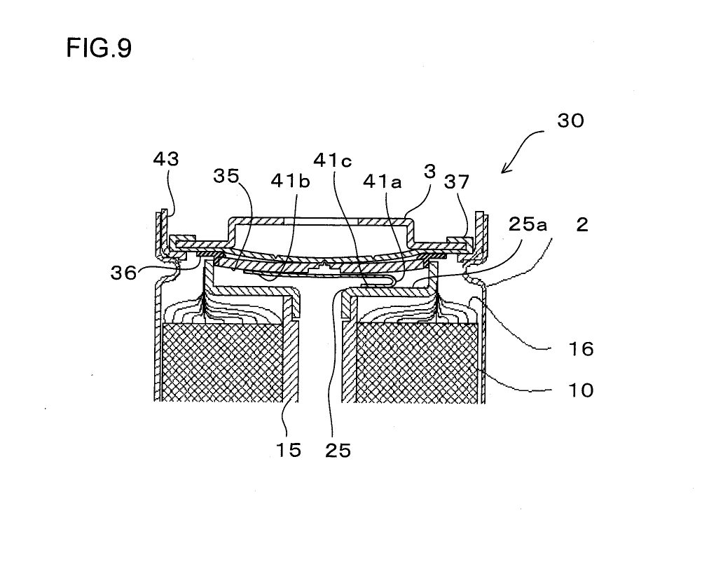

FIG. 9 is a sectional view showing the region of junction between the lid unit 30 and the electrode group 10 in a second embodiment of the secondary cell according to the present invention. The feature by which this secondary cell according to the second embodiment differs from the secondary cell according to the first embodiment is that the folding portion 41a of the lead plate 41 is formed in the neighborhood of the other end portion 41c. In other words, the lead plate 41 is bent through 180° into a letter-U shape at the portion close to the other end portion 41c where it is joined to the upper surface of the base portion 25a of the positive electrode current collecting member 25, and its one end portion 41b extends to the opposite side of the central plane from that other end portion 41c, or, to put it in another manner, extends to the opposite side of the winding core 15. And this one end portion 41b is joined to the connection plate 35 of the lid unit 30 at a location that lies within the upper cylindrical portion 25c of the positive electrode current collecting member 25.

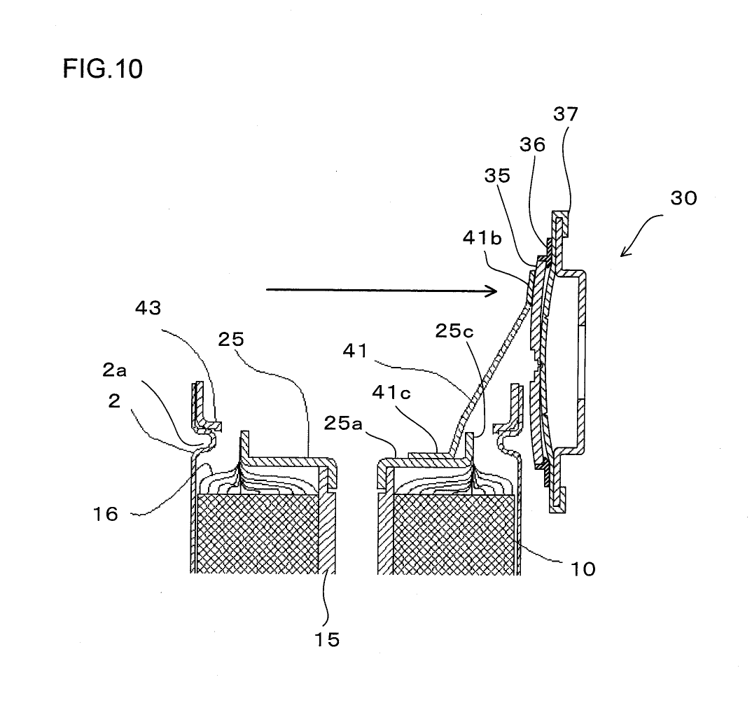

FIG. 10 is a sectional view for explaining the method of making the secondary cell of this second embodiment. The other end portion 41c of the lead plate 41 is joined by ultrasonic welding or the like to the upper surface of the base portion 25a of the positive electrode current collecting member 25, as follows. This welding is performed in the state in which the one end portion 41b of the lead plate 41 has been pulled out to the outside of the upper cylindrical portion 25c of the positive electrode current collecting member 25 on the same side of the central plane as the other end portion 41c thereof. The welding may also be performed after pulling out the one end portion of the lead plate 41, in plan view, beyond the containing wall of the cell container 2.

After the other end portion 41c of the lead plate 41 has been welded to the positive electrode current collecting member 25, as shown in FIG. 10, the lead plate 41 is held by a holding jig (not shown in the figures) in the state in which it is almost vertical, and in which the one end portion 41b of the lead plate 41 is contacted against a junction spot on the connection plate 35 of the lid unit 30, that itself is also held so as to be almost vertical. In this state, the conjoined spots of the one end portion of the lead plate 41 and of the connection plate 35 of the lid unit 30 that are to be joined together are positioned above and outside the cell container 2. And a laser light is irradiated upon these conjoined spots in the direction shown by the arrow. In this case as well, the junction surface of the lead plate 41 by which its one end portion 41b is joined to the connection plate 35 of the lid unit 30, and its junction surface by which its other end portion 41c is joined to the base portion 25a of the positive electrode current collecting member 25, are of the same side thereof. Moreover, the welding conditions are the same as in the first embodiment.

After the one end portion 41b of the lead plate 41 has been welded to the connection plate 35 of the lid unit 30, the lead plate 41 and the lid unit 30 are rotated in the anti-clockwise direction in FIG. 10, around the portion close to the other end portion 41c of the lead plate 41 as a rotation axis. Due to this rotation, the folding portion 41a is formed on the lead plate 41. Subsequently, the peripheral part of the diaphragm of the lid unit 30 is mounted upon the gasket 43, and then the secondary cell 1 is sealed up in a similar manner to the case with the first embodiment.

In the above description, a case has been explained in which the laser welding between the one end portion 41b of the lead plate 41 and the connection plate 35 of the lid unit 30 is performed with the lead plate 41 and the lid unit 30 in the nearly vertical state. However, it would also be possible to perform the laser welding with the lead plate 41 and the lid unit 30 in a state somewhat rotated further in the clockwise direction in FIG. 10, or, to put it in another manner, in the state with the surfaces of the connection plate 35 and the lead plate 41 that are to be welded together tilted in the upward facing direction. Or, conversely, it would also be acceptable to perform the laser welding with the lead plate 41 and the lid unit 30 in a position rotated slightly in the anti-clockwise direction from the vertical; the point is, that a position should be adopted so that the irradiation of the laser light is not hindered by the cell container 2.

In this second embodiment, the other end portion 41c of the lead plate 41 is welded by ultrasonic welding to the positive electrode current collecting member 25 in the state in which it is pulled out further to the exterior than the side of the positive electrode current collecting member 25, on the same side of the central plane as the one end portion 41b. And the one end portion 41b of the lead plate 41 is welded by laser welding to the connection plate 35 in the state in which it is pulled out to the exterior of the cell container 2 on the same side of the central plane as the other end portion 41c. Due to this, it becomes possible to shorten the lead plate 41, in the same manner as in the case of the first embodiment.

### Embodiment 3

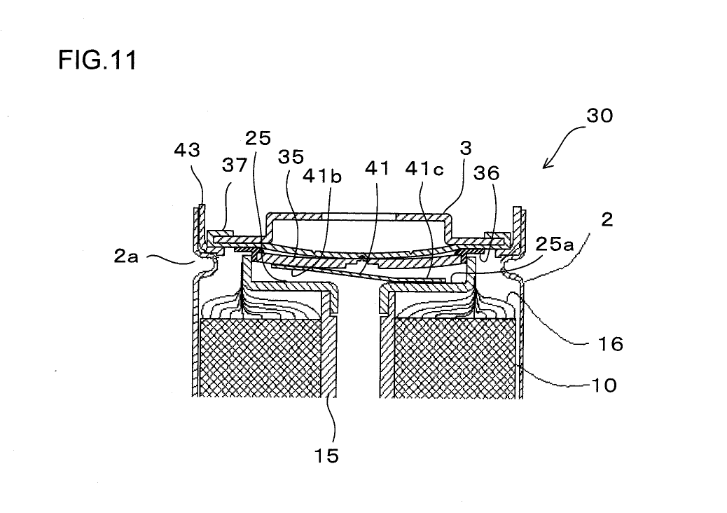

FIG. 11 is a sectional view showing the region of junction between the lid unit 30 and the electrode group 10 in a third embodiment of the secondary cell according to the present invention.

The feature by which this third embodiment differs from the other embodiments is that no folded portion is formed in the lead plate 41.

In more detail, as shown in FIG. 11, while the other end portion 41c of the lead plate 41 is connected to the upper surface of the base portion 25a of the positive electrode current collecting member 25, its one end portion 41b extends in a substantially rectilinear shape to the opposite side of the central plane relative to the other end portion 41c, and is then joined to the connection plate 35 with no folded portion or sharply curved portion or the like being provided between the one end portion 41b and the other end portion 41c, like the folding portion 41a of the previous embodiments. Here a “substantially rectilinear shape” means that there is no folded portion or sharply curved portion, and is not intended to exclude the possibility of a gentle curve or a modest twist or the like; it should be understood that the lead plate 41 may bend to and fro somewhat. In this case, the junction surface of the lead plate 41 by which its one end portion 41b is joined to the lower surface of the connection plate 35 of the lid unit 30, and its junction surface by which its other end portion 41c is joined to the base portion 25a of the positive electrode current collecting member 25, are respectively of different sides thereof. Moreover, the one end portion 41b of the lead plate 41 that is joined to the connection plate 35 is still within the upper cylindrical portion 25c of the positive electrode current collecting member 25.

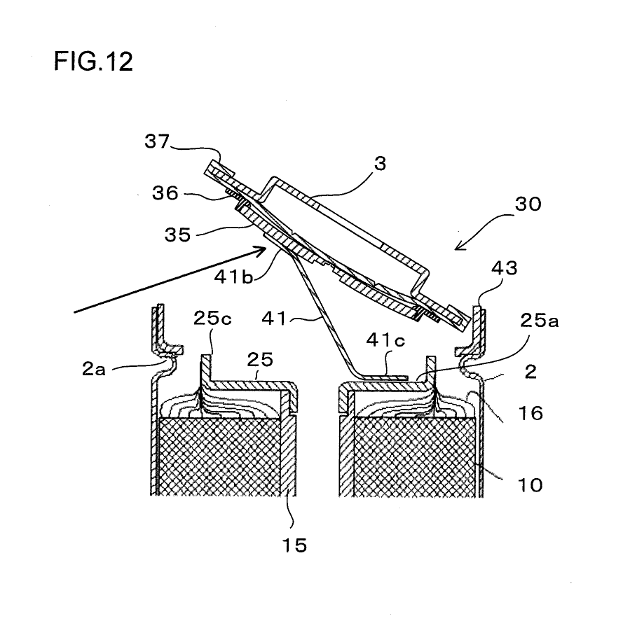

FIG. 12 is a sectional view for explaining the method of connection in this third embodiment of the present invention shown in FIG. 11.

First, the other end portion 41c of the lead plate 41 is connected to the upper surface of the base portion 25a of the positive electrode current collecting member 25 by ultrasonic welding or the like. At this time, the one end portion 41b of the lead plate 41 is brought to the opposite side of the central plane from the other end portion 41c, but still within the upper cylindrical portion 25c of the positive electrode current collecting member 25.

Next, the one end portion 41b of the lead plate 41 is rotated through less than 90° in the clockwise direction around the portion close to the other end portion 41c of the lead plate 41 as a rotation axis, as shown in FIG. 12. At this time, even after this rotation has been completed, the state of the one end portion 41b of the lead plate 41 as being positioned on the opposite side of the central plane from the other end portion 41c does not change. And the junction spot where the connection plate 35 of the lid unit 30 is to be connected to the one end portion 41b of the lead plate 41 is held with a holding jig (not shown in the drawings), so that they are kept in mutual contact. Due to this, the lid unit 30 is tilted as shown in FIG. 12. In other words, the junction spot on the connection plate 35 of the lid unit 30 is positioned higher than the top of the cell container 2, and moreover the lid unit 30 is tilted so that the portion at its other side is still within the cell container 2.

While the members are in this state and are being held by the holding jig (not shown in the drawings), a laser light is irradiated on them in the direction shown by the arrow sign, and laser welding is performed. In this case, the junction surface of the other end portion 41c of the lead plate 41 where it contacts to the connection plate 35 of the lid unit 30 is the opposite surface thereof to the junction surface of the one end portion 41b where it is joined to the base portion 25a of the positive electrode current collecting member 25. Moreover, the welding conditions are the same as in the first embodiment.

In this third embodiment of the present invention, the one end portion 41b of the lead plate 41 is disposed at a position on the opposite side of the central plane to the other end portion 41c that is joined to the positive electrode current collecting member 25, and moreover within the external periphery of the positive electrode current collecting member 25. And the one end portion 41b of the lead plate 41 is welded by laser welding to the connection plate 35 of the lid unit 30 by being irradiated with the laser light, in the state in which it has been raised through a range less than 90° with respect to the junction surface of the other end portion 41c where it is joined to the positive electrode current collecting member 25. Due to this, it becomes possible to connect together the positive electrode current collecting member 25 and the connection plate 35 with the lead plate 41, without creating any folded portion in the lead plate 41 such as the folding portions 41a of the first and the second embodiments.

Accordingly it is possible to make the lead plate 41 shorter than in the cases of the first and second embodiments.

### Embodiment 4

In the first through the third embodiments, constructions were adopted in which the one end portion 41b of the lead plate 41 that was joined to the lid unit 30 and the other end portion 41c of the lead plate 41 that was joined to the positive electrode current collecting member 25 were positioned on opposite sides of the central plane.

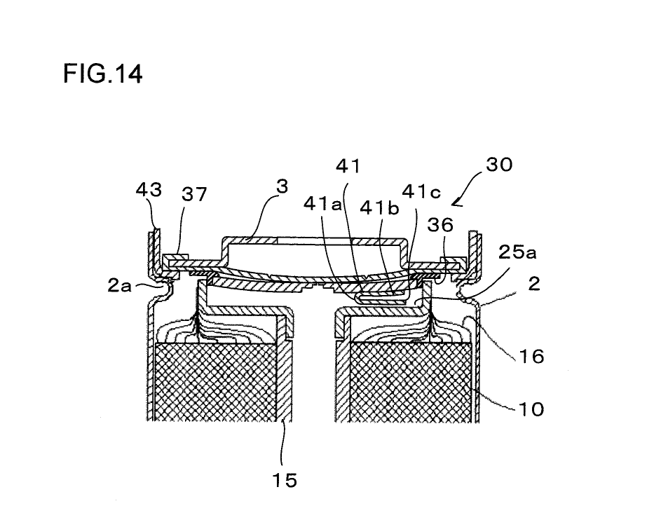

By contrast, with the cylindrical secondary cell 1 of the fourth embodiment shown in FIG. 14, a construction is adopted in which the one end portion 41b of the lead plate 41 that was joined to the lid unit 30 and the other end portion 41c of the lead plate 41 that was joined to the positive electrode current collecting member 25 are positioned on the same side of the central plane. Moreover, the folding portion 41a of the lead plate 41 is also positioned on the same side of the central plane as its one end portion 41b and its other end portion 41c. Due to this, the total length of the lead plate 41 becomes shorter, and it is possible to anticipate that its electrical resistance will be lower.

FIG. 15 is a sectional view showing the method of manufacturing this with the cylindrical secondary cell 1 of the fourth embodiment shown in FIG. 14.

First, the other end portion 41c of the lead plate 41 is connected to the upper surface of the base portion 25a of the positive electrode current collecting member 25 by ultrasonic welding or the like.

Next, one end portion 41b of the lead plate 41 welded to the lid unit 30 is positioned above and within the gasket 43, in other words, the lid unit 30 is tilted upwards so that the end portion 41b of the lead plate 41 is positioned externally to the cell container 2. Due to this, a gap is created between the side of the lid unit 30 where the lead plate 41 is welded and the upper edge of the cell container 2, and the lid unit 30 is then held in this state by a holding jig not shown in the figures. And the lead plate 41 is folded at a folding portion 41a, and its one end portion 41b is pressed into contact with the lower surface of the connection plate 35 of the lid unit 30 by the restoring force provided by the lead plate 41 itself, that is elastic. In this case, the position of the one end portion 41b of the lead plate 41 where it contacts the connection plate 35 is on the same side of the central plane as the position of the other end portion 41c of the lead plate 41 where it is joined to the positive electrode current collecting member 25; and, moreover, the positions in the circumferential direction and in the radial direction of the one end portion 41b where it contacts the connection plate 35 are approximately the same as the positions in the circumferential direction and in the radial direction of the other end portion 41c where it is connected to the positive electrode current collecting member 25. In other words the positions are so arranged that the gap between the lid unit 30 and the cell container 2 is maximized, while obtaining the shortest possible length for the lead plate 41.

In this state, as shown in FIG. 15, a laser fiber optic light guide (i.e. a laser light guide member 50 is inserted into the cell container 2, through the gap between the lid unit 30 and the cell container 2. And the laser light exit 51 of the laser light fiber optic guide 50 is positioned so as to face the contact portion between the one end portion 41b of the lead plate 41 and the connection plate 35, and laser light is irradiated upon this contact portion, thus connecting together the one end portion 41b of the lead plate 41 and the connection plate 35.

When the welding has been completed, as shown in FIG. 14, the entire lid unit 30 is put back within the gasket 43 at the top of the cell container 2. When the entire lid unit 30 has thus been put into the gasket 30, as shown in FIG. 14, the lead plate 41 is folded back so as to create a folding portion 41a at an intermediate portion thereof. Subsequently, the cell container 2 is sealed up, in a similar manner to the first embodiment.

With this secondary cell 1 according to the fourth embodiment of the present invention, the one end portion 41b of the lead plate 41 that is connected to the lid unit 30 and the other end portion 41c of the lead plate 41 that is connected to the positive electrode current collecting member 25 are positioned on the same side of the central plane. Moreover, the folding portion 41a of the lead plate 41 does not reach past the central plane; rather, the lead plate 41 is folded on the same side of the central plane as the one end portion 41b and other end portion 41c. Due to this, the advantageous effect is obtained that the total length of the lead plate 41 is even shorter than in the other embodiments described above, and it may be supposed that, to which extent, the internal resistance of this secondary cell 1 is lower.

It should be understood that while, in FIG. 14, the folding portion 41a that is positioned between the one end portion 41b of the lead plate 41 and its other end portion 41c is shown in a state of being folded through an angle of approximately 360°, if the gap between the positive electrode current collecting member 25 and the lid unit 30 is large, this folded portion may be bent through a more gentle curve with a smaller angle of folding. In this description of the present invention, the term “folding” should also be understood as including this type of gentle bending around, as well as complete folding.

Moreover, in this fourth embodiment, it would also be acceptable to arrange to weld the one end portion 41b of the lead plate 41 to the connection plate 35 in advance, and then to insert the laser light fiber optic guide 50 in through the gap between the lid unit 30 and the cell container 2, and to weld the other end portion 41c of the lead plate 41 to the positive electrode current collecting member 25 by laser welding. Furthermore, while in FIG. 15 the case was explained in which the laser light fiber optic guide 50 was inserted into the cell container 2 through the gap between the lid unit 30 and the cell container 2 in the state with the lid unit 30 tilted, it would also be acceptable not to tilt the lid unit 30, but to hold it parallel with the base portion 25a of the positive electrode current collecting member 25, and, in this state, to insert the laser fiber optic light guide 50 in through the gap between the lid unit 30 and the cell container 2.

It would also be acceptable to arrange to employ a laser light fiber optic guide 50 in the first through the third embodiments as well, during the laser welding of the lead plate 41 to the positive electrode member 25 and to the lid unit 30. In particular, in the third embodiment, since no folding portion 41a of the lead plate 41 is formed, and since the total length of the lead plate 41 is short, accordingly the method of employing a laser light fiber optic guide 50 is particularly effective.

Furthermore, in the embodiments described above, structures were described in which the lid unit 30 was made up from the lid member 3, the diaphragm 37, the connection plate 35, and the insulation plate 36. However, the lid unit 30 should not be considered as being limited to this type of structure. For example, a construction would also be acceptable in which the diaphragm 37 and the connection plate 35 were made as a unified member, or alternatively the vertical arrangement of the diaphragm 37 and the connection plate 35 could be reversed; thus the present invention can be widely applied to any lid unit that has a member that can serve for being electrically connected to the positive electrode current collecting member, and a member that can serve as a cell terminal.

While, in the embodiments described above, cases were explained in which the positive electrode was connected to the lid unit 30, it would also be possible to apply the present invention to a case in which the negative electrode is connected to the lid unit 30.

Moreover while, in the embodiments described above, the explanation was made in terms of the cylindrical secondary cell of the present invention being a lithium cell, the present invention is not to be considered as being limited to application to a lithium cell; it would also be possible to apply the present invention to some other type of cylindrical secondary cell, such as a nickel-hydrogen cell, a nickel-cadmium cell, or the like.

As described above, according to one aspect of the present invention, the secondary cell of the present invention has a construction in which the current collecting member and the lid unit are only electrically connected together by the single electrically conductive lead, of which the one end portion that is connected to the lid unit is positioned opposite relative to the central plane of the container from the other end portion that is connected to the current collecting member, and that furthermore has one folded portion at a location partway therealong, or none. Furthermore, according to another aspect of the present invention, the secondary cell of the present invention has a construction in which the current collecting member and the lid unit are only electrically connected together by the single electrically conductive lead, of which the one end portion that is connected to the lid unit and a folded portion that is positioned between the one end portion and the other end portion are both positioned on the same side of the central plane of the container as the other end portion that is connected to the current collecting member. Due to the above, it is possible to make the electrically conductive lead short in length. Furthermore, according to one aspect of the method of manufacture of a secondary cell according to the present invention, the one end portion of the electrically conductive lead, of which the other end portion is joined to the current collecting member, is pulled out to the exterior of the cell container and is joined to the lid unit. Moreover, according to another aspect of the method of manufacture of a secondary cell according to the present invention, there are included a process of joining the other end portion of the electrically conductive lead to the current collecting member; a process of inserting a laser light guide member between the lid unit and the current collecting member; and a process of joining the one end portion of the electrically conductive lead to the lid unit. Due to this, it is possible to connect together the current collecting member and the lid unit, even if the length of the electrically conductive lead is short.

It should be understood that, within the scope of the range of the present invention, various changes and additions can be made to any embodiment thereof; and, accordingly, according to one device aspect of the present invention, the secondary cell of the present invention is a secondary cell, comprising: a cell container receiving an electrode group, a current collecting member, a flexible electrically conductive lead and an electrolyte, and sealed with a lid unit via an insulation member; wherein the electrode group comprises a positive electrode and a negative electrode wound around a winding core; and wherein the current collecting member is arranged on the upper portion of the electrode group; and wherein one of the positive electrode and the negative electrode is connected to the current collecting member; and wherein the lid unit is arranged on the current collecting member; and wherein one end portion of the electrically conductive lead is connected to the lid unit; and wherein other end portion of the electrically conductive lead is connected to the current collecting member; and the current collecting member and the lid unit are electrically connected together by the single electrically conductive lead, of which the one end portion that is connected to the lid unit is positioned opposite relative to a central plane of the container from the other end portion that is connected to the current collecting member, and that furthermore has one folded portion at a location partway therealong, or none.

And, according to another device aspect of the present invention, the secondary cell of the present invention is a secondary cell, comprising: a cell container receiving an electrode group, a current collecting member, a flexible electrically conductive lead and an electrolyte, and sealed with a lid unit via an insulation member; wherein the electrode group comprises a positive electrode and a negative electrode wound around a winding core; and wherein the current collecting member is arranged on the upper portion of the electrode group; and wherein one of the positive electrode and the negative electrode is connected to the current collecting member; and wherein the lid unit is arranged on the current collecting member; and wherein one end portion of the electrically conductive lead is connected to the lid unit; and wherein other end portion of the electrically conductive lead is connected to the current collecting member; and the current collecting member and the lid unit are electrically connected together by a single electrically conductive lead, of which one end portion that is connected to the lid unit and a folded portion that is positioned between the one end portion and the other end portion are both positioned on a same side relative to a central plane of the container as the other end portion that is connected to the current collecting member.

Moreover, according to one method aspect of the present invention, the present invention is a method of manufacturing a secondary cell that comprises: a cell container receiving an electrode group, a current collecting member, a flexible electrically conductive lead and an electrolyte, and sealed with a lid unit via an insulation member; wherein the electrode group comprises a positive electrode and a negative electrode wound around a winding core; and wherein the current collecting member is arranged on the upper portion of the electrode group; and wherein one of the positive electrode and the negative electrode is connected to the current collecting member; and wherein the lid unit is arranged on the current collecting member; and wherein one end portion of the electrically conductive lead is connected to the lid unit; and wherein other end portion of the electrically conductive lead is connected to the current collecting member; comprises: a process of joining the other end portion of the electrically conductive lead to the current collecting member; a process of pulling the one end portion of the electrically conductive lead out to the exterior of the cell container and joining it to the lid unit; and a process of swaging the lid unit to the cell container with the interposition of the insulation member, so as to seal up the interior of the cell container and isolate it from the exterior. And, according to another method aspect of the present invention, the present invention is a method of manufacturing a secondary cell that comprises: a cell container receiving an electrode group, a current collecting member, a flexible electrically conductive lead and an electrolyte, and sealed with a lid unit via an insulation member; wherein the electrode group comprises a positive electrode and a negative electrode wound around a winding core; and wherein the current collecting member is arranged on the upper portion of the electrode group; and wherein one of the positive electrode and the negative electrode is connected to the current collecting member; and wherein the lid unit is arranged on the current collecting member; and wherein one end portion of the electrically conductive lead is connected to the lid unit; and wherein other end portion of the electrically conductive lead is connected to the current collecting member; comprising: a process of joining the other end portion of the electrically conductive lead to the current collecting member; a process of inserting a laser light guide member between the lid unit and the current collecting member; a process of joining the one end portion of the electrically conductive lead to the lid unit; and a process of swaging the lid unit to the cell container with the interposition of the insulation member, so as to seal up the interior of the cell container and isolate it from the exterior.

The above described embodiments are examples, and various modifications can be made without departing from the scope of the invention.

What is claimed is:

1. A secondary cell, comprising:
a cell container receiving an electrode group, a current collecting member, a flexible electrically conductive lead and an electrolyte, and sealed with a lid unit via an insulation member;
wherein the electrode group comprises a positive electrode and a negative electrode wound around a winding core; and wherein
the current collecting member is arranged on the upper portion of the electrode group; and wherein
one of the positive electrode and the negative electrode is connected to the current collecting member; and wherein
the lid unit is arranged on the current collecting member; and wherein
one end portion of the electrically conductive lead is connected to the lid unit; and wherein
other end portion of the electrically conductive lead is connected to the current collecting member;
and
the current collecting member and the lid unit are electrically connected together by the electrically conductive lead, of which the one end portion that is connected to the lid unit is positioned opposite relative to a central plane of the container from the other end portion that is connected to the current collecting member, and that furthermore has one folded portion at a location partway therealong, or none.

2. A secondary cell comprising:
a cell container receiving an electrode group, a current collecting member, a flexible electrically conductive lead and an electrolyte, and sealed with a lid unit via an insulation member;
wherein the electrode group comprises a positive electrode and a negative electrode wound around a winding core; and wherein
the current collecting member is arranged on the upper portion of the electrode group; and wherein
one of the positive electrode and the negative electrode is connected to the current collecting member; and wherein
the lid unit is arranged on the current collecting member; and wherein
one end portion of the electrically conductive lead is connected to the lid unit; and wherein
other end portion of the electrically conductive lead is connected to the current collecting member;
and
the current collecting member and the lid unit are electrically connected together by the electrically conductive lead, of which the one end portion that is connected to the lid unit and a folded portion that is positioned between the one end portion and the other end portion are both positioned on a same side relative to a central plane of the container as the other end portion that is connected to the current collecting member.

3. A secondary cell according to claim 1, wherein the electrically conductive lead is formed by laminating together a plurality of thin electrically conductive layers, and the surface of the electrically conductive lead is covered with an insulation layer, except for the other end portion that is connected to the current collecting member and the one end portion that is connected to the lid unit.

4. A secondary cell according to claim 1, wherein the electrically conductive lead has the folded portion in the vicinity of the one end portion that is connected to the lid unit.

5. A secondary cell according to claim 1, wherein the electrically conductive lead has the folded portion in the vicinity of the other end portion that is connected to the current collecting member.

6. A secondary cell according to claim 1, wherein the electrically conductive lead is formed in an approximately rectilinear shape from the other end portion that is connected to the current collecting member to the one end portion that is connected to the lid unit, with no portion thereof being substantially curved.

7. A secondary cell according to claim 1, wherein the lid unit comprises a connection plate to which the one end portion of the electrically conductive lead is connected, a diaphragm to which the connection plate is connected, and a lid member that is swaged to the diaphragm.

8. A method for manufacturing a secondary cell that comprises:
a cell container receiving an electrode group, a current collecting member, a flexible electrically conductive lead and an electrolyte, and sealed with a lid unit via an insulation member;
wherein the electrode group comprises a positive electrode and a negative electrode wound around a winding core; and wherein
the current collecting member is arranged on the upper portion of the electrode group; and wherein
one of the positive electrode and the negative electrode is connected to the current collecting member; and wherein
the lid unit is arranged on the current collecting member; and wherein
one end portion of the electrically conductive lead is connected to the lid unit; and wherein
other end portion of the electrically conductive lead is connected to the current collecting member;
comprising:
a process of joining the other end portion of the electrically conductive lead to the current collecting member;
a process of pulling the one end portion of the electrically conductive lead out to the exterior of the cell container and joining it to the lid unit; and
a process of swaging the lid unit to the cell container with the interposition of the insulation member, so as to seal up the interior of the cell container and isolate it from the exterior.

9. A method for manufacturing a secondary cell according to claim 8, wherein the process of pulling the one end portion of the electrically conductive lead out to the exterior of the cell container and joining it to the lid unit is a process of positioning the one end portion of the electrically conductive lead opposite relative to the central plane from the other end portion that is joined to the current collecting member, and moreover joining it to the lid unit so that a folded portion is created at one location partway therealong, or none.

10. A method for manufacturing a secondary cell according to claim 8, wherein the process of joining the other end portion of the electrically conductive lead to the current collecting member is performed by positioning the one end portion of the electrically conductive lead opposite relative to the central plane from the other end portion thereof, and the process of pulling the one end portion of the electrically conductive lead out to the exterior of the cell container and joining it to the lid unit is performed by pulling out the one end portion of the electrically conductive lead to a same side relative to the central plane as the other end portion of the electrically conductive lead, so that the folded portion of the electrically conductive lead is formed near the one end portion thereof which is joined to the lid unit.

11. A method for manufacturing a secondary cell according to claim 8, wherein the process of joining the other end portion of the electrically conductive lead to the current collecting member is performed by positioning the one end portion of the electrically conductive lead on a same side relative to the central plane as the other end portion thereof, and the process of pulling the one end portion of the electrically conductive lead out to the exterior of the cell container and joining it to the lid unit is performed by pulling out the one end portion of the electrically conductive lead to the same side relative to the central plane as the other end portion of the electrically conductive lead, so that the folded portion of the electrically conductive lead is formed near the other end portion thereof which is joined to the current collecting member.

12. A method for manufacturing a secondary cell according to claim 8, wherein the process of joining the other end portion of the electrically conductive lead to the electrode current collecting member is performed by positioning the one end portion of the electrically conductive lead opposite relative to the central plane from the other end portion thereof, and the process of pulling the one end portion of the electrically conductive lead out to the exterior of the cell container and joining it to the lid unit is performed by tilting the one end portion of the electrically conductive lead at an angle of less than 90° with respect to the junction surface where the other end portion of the electrically conductive lead is joined to the current collecting member, so that no such folded portion of the electrically conductive lead is formed.

13. A method for manufacturing a secondary cell according to claim 8, wherein the lid unit comprises a connection plate to which the one end portion of the electrically conductive lead is joined, a diaphragm that is joined to the connection plate, and a lid member that is swaged to the diaphragm; and the process of pulling the other end portion of the electrically conductive lead out to the exterior of the cell container and joining it to the lid unit is performed by laser welding by irradiation with a laser light.

14. A method for manufacturing a secondary cell that comprises:
a cell container receiving an electrode group, a current collecting member, a flexible electrically conductive lead and an electrolyte, and sealed with a lid unit via an insulation member;
wherein the electrode group comprises a positive electrode and a negative electrode wound around a winding core; and wherein
the current collecting member is arranged on the upper portion of the electrode group; and wherein
one of the positive electrode and the negative electrode is connected to the current collecting member; and wherein
the lid unit is arranged on the current collecting member; and wherein
one end portion of the electrically conductive lead is connected to the lid unit; and wherein
other end portion of the electrically conductive lead is connected to the current collecting member;
comprising:
a process of joining the other end portion of the electrically conductive lead to the current collecting member;
a process of inserting a laser light guide member between the lid unit and the current collecting member;
a process of joining the one end portion of the electrically conductive lead to the lid unit; and
a process of swaging the lid unit to the cell container with the interposition of the insulation member, so as to seal up the interior of the cell container and isolate it from the exterior.

15. A method for manufacturing a secondary cell according to claim 14, wherein the process of joining the one end portion of the electrically conductive lead to the lid unit is a process that is performed after the process of joining the other end portion of the electrically conductive lead to the current collecting member, and includes a process of performing laser welding with the laser light guide member that is inserted between the lid unit and the current collecting member.

16. A method for manufacturing a secondary cell according to claim 14, wherein the process of joining the other end portion of the electrically conductive lead to the current collecting member is a process that is performed after the process of joining the one end portion of the electrically conductive lead to the lid unit, and includes a process of performing laser welding with the laser light guide member that is inserted between the lid unit and the current collecting member.

17. A secondary cell according to claim 1, wherein the electrically conductive lead has only one folded portion in the vicinity of the one end portion that is connected to the current collecting member.

18. A secondary cell according to claim 1, wherein the electrically conductive lead has only one folded portion in the vicinity of the other end portion that is connected to the current collecting member.
